(19) United States
(12) Patent Application Publication
(10) Pub. No.: US 2011/0043724 A1
(43) Pub. Date: Feb. 24, 2011

(54) Backlight unit and display device using the same

(76) Inventor: Tae Ho Kim, Seoul (KR)

Correspondence Address: MCKENNA LONG & ALDRIDGE LLP, 1900 K STREET, NW, WASHINGTON, DC, 20006, US

(21) Appl. No.: 12/656,502

(22) Filed: Feb. 1, 2010

(30) Foreign Application Priority Data
Aug. 21, 2009 (KR) 10-2009-0077740

(51) Int. Cl. G02F 1/13357; G09F 13/04

(52) U.S. Cl. 349/65; 362/97.1

(57) ABSTRACT

The backlight unit comprises a bottom cover, a light guide plate on which a reflection layer is disposed on at least one side surface thereof, the light guide plate being disposed on an inside of the bottom cover, and a light emitting module disposed on at least one side surface of the light guide plate.

The present application claims priority under 35 U.S.C. 119 and 35 U.S.C. 365 to Korean Patent Application No. 10-2009-0077740 filed on Aug. 21, 2009, which is hereby incorporated by reference in its entirety.

### BACKGROUND

Embodiments relate to a backlight unit and a display device using the same.

Liquid crystal display devices (LCDs) are receiving public attention due to various advantages such as compactness, lightness, and low power consumption. That is, the LCDs have attracted public interest as a substitute that overcome limitations of a cathode ray tube (CRT) and thus, are becoming widely used in almost all information processing devices that require a display unit.

Since an LCD device itself does not emit light, the LCD device requires a separate light source such as a backlight unit (BLU). Many researches for effectively utilizing light emitted from the BLU are in progress in order to provide a high-quality image in the LCD device.

### SUMMARY

In one embodiment, a backlight unit comprises: a bottom cover; a light guide plate on which a reflection layer is disposed on at least one side surface thereof, the light guide plate being disposed on an inside of the bottom cover; and a light emitting module disposed on at least one side surface of the light guide plate.

In another embodiment, a backlight unit comprises: a bottom cover; a light guide plate on which a reflection layer is disposed on at least one side surface thereof, the light guide plate being disposed on an inside of the bottom cover; and a light emitting module disposed on an under surface of the light guide plate.

In further another embodiment, a display device comprises: a backlight unit comprising a bottom cover, a light guide plate on which a reflection layer is disposed on at least one side surface thereof, the light guide plate being disposed on an inside the of bottom cover, and a light emitting module disposed on at least one side surface of the light guide plate; and a liquid crystal panel on the backlight unit.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view of a backlight unit according to a first embodiment.

FIG. 2 is an exploded perspective view of the backlight unit of FIG. 1.

FIG. 3 is a perspective view illustrating a light guide plate of the backlight unit of FIG. 1.

FIG. 4 is a perspective view illustrating a light guide plate of a backlight unit according to a second embodiment.

FIG. 5 is a side view illustrating a light guide plate of a backlight unit according to a third embodiment.

### DETAILED DESCRIPTION OF THE EMBODIMENTS

In the description of embodiments, it will be understood that when a layer (or film), region, pattern or structure is referred to as being ‘on’ another layer (or film), region, pad or pattern, the terminology of ‘on’ and ‘under’ includes both the meanings of ‘directly’ and ‘indirectly’.

In the drawings, the thickness or size of each layer is exaggerated, omitted, or schematically illustrated for convenience in description and clarity. Also, the size of each element may not entirely reflect an actual size.

Hereinafter, a backlight unit and a display device using the same according to embodiments will be described with reference to the accompanying drawings.

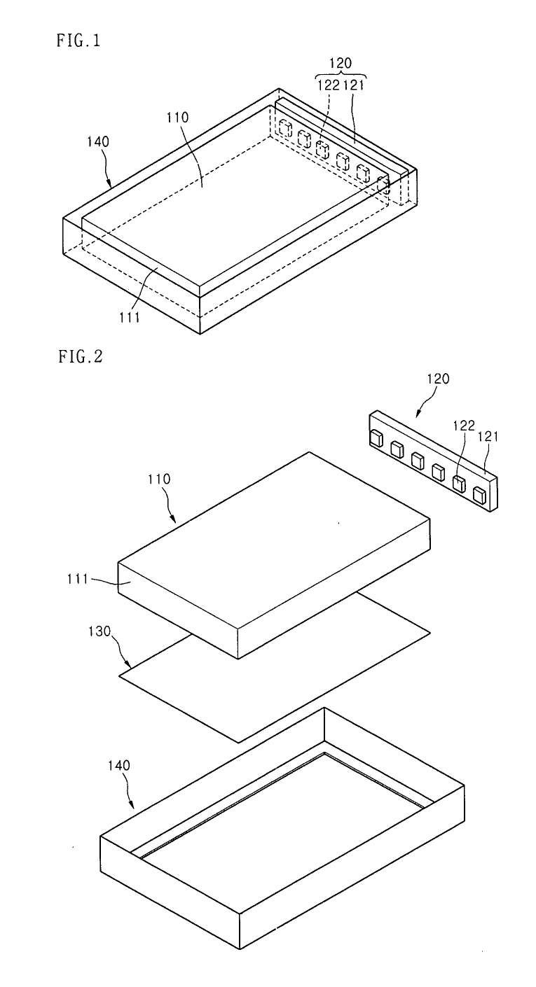

FIG. 1 is a perspective view of a backlight unit according to a first embodiment, and FIG. 2 is an exploded perspective view of the backlight unit of FIG. 1.

Referring to FIGS. 1 and 2, a backlight unit (BLU) may include a bottom cover 140, a light guide plate 110, and a light emitting module 120. The light guide plate 110 is disposed inside the bottom cover 140, and a reflection layer 111 is disposed on at least one side surface of the light guide plate 110. In this embodiment, the light emitting module 120 is disposed on at least one side surface of the light guide plate 110. Alternatively, the light emitting module 120 may be disposed at a bottom surface of the light guide plate 110. Also, a reflection sheet 130 may be disposed below the light guide plate 110.

The bottom cover 140 may have an upwardly opened box shape to receive the light guide plate 110, the light emitting module 120, and the reflection sheet 130, but is not limited thereto.

The bottom cover 140 may be formed with metal material or a resin material. The bottom cover 140 may be manufactured using a press forming process or an extrusion molding process.

The light emitting module 120 may include a substrate 121 and a plurality of light emitting devices 122 mounted on the substrate 121.

The substrate 121 may include a general printed circuit board (PCB), a metal core printed circuit board (MCPCB), a flexible printed circuit board (FPCB), or a ceramic substrate, but is not limited thereto.

The plurality of light emitting devices 122 may be mounted on a surface of the substrate 121 and disposed in an array form. For example, the plurality of light emitting devices 122 may include light emitting diodes (LEDs). The LED may be one of a red LED, a green LED, a blue LED, and a white LED, which respectively emit red color, green color, blue color, and white color. The light emitting devices 122 are not limited to the number, arrangement, and color thereof.

As shown in FIGS. 1 and 2, the light emitting module 120 may be disposed on at least one inner side surface of the bottom cover 140, and thus, the light emitting module 120 may provide light toward at least one side surface of the light guide plate 110.

Alternatively, the light emitting module 120 may be disposed at a bottom surface of the bottom cover 140 to provide light toward an under surface of the light guide plate 110. It should be noted that the light emitting module 120 may be disposed in various ways based on the design of the BLU.

The light guide plate 110 may be disposed inside the bottom cover 140. The light guide plate 110 may receive light provided from the light emitting module 120 to produce planar light, which is guided to a liquid crystal panel (not shown).

The light guide plate 110 may be formed with one of a resin-based material such as polymethylmethacrylate (PMMA), a polyethylene terephthalate (PET) resin, a poly carbonate (PC) resin, a cyclic olefin copolymer (COC) resin, and a polyethylene naphthalate (PEN) resin. For example, the light guide plate 110 may be manufactured using an extrusion molding process.

The light guide plate 110 may have a thickness of about 1 mm to about 2 mm, but is not limited thereto.

A scattering pattern may be formed at an under surface of the light guide plate 110. As a result, light may be scattered and diffused by the scattering pattern to improve light uniformity.

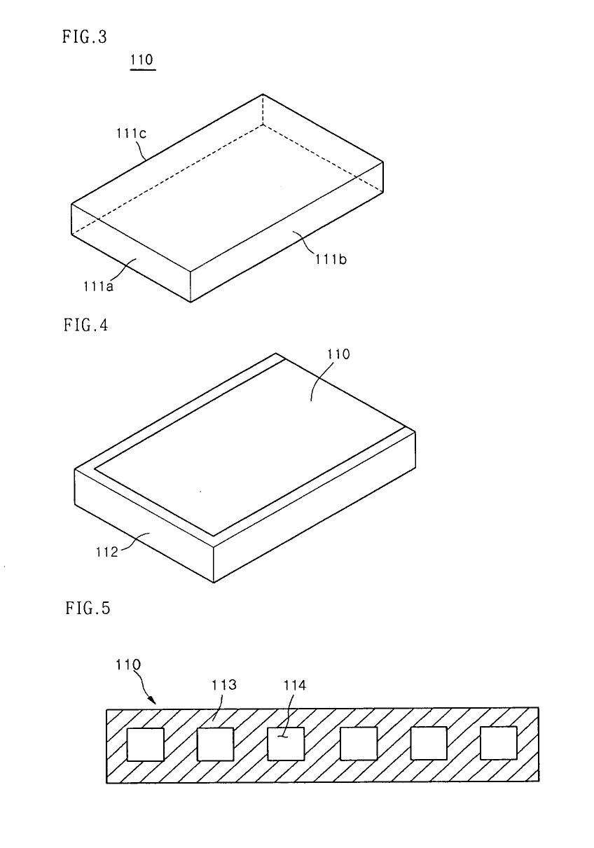

FIG. 3 is a perspective view illustrating a light guide plate of the backlight unit of FIG. 1.

Referring to FIGS. 1 to 3, the reflection layer 111 (111a, 111b, and 111c) may be disposed on at least one side surface of the light guide plate 110.

For example, the reflection layer 111 may be disposed on side surfaces of the light guide plate 110 except for the side surface on which the light emitting module 120 is disposed. If the light emitting module 120 is disposed below the light guide plate 110, the reflection layer 111 may be disposed on all side surfaces of the light guide plate 110, but is not limited thereto.

The reflection layer 111 may reflect light incident to at least one side surface of the light guide plate 110 to minimize light loss of the BLU.

The reflection layer 111 may prevent light emitted through at least one side surface of the light guide plate 110 from being lost in a space between the side surfaces of the light guide plate 110 and the inner side surfaces of the bottom cover 140.

The reflection layer 111 may be formed of a material having high reflectivity. For example, a white photo solder resist (PSR) ink or oxide titanium (TiO₂) may be coated on a surface of the light guide plate 110 to form the reflection layer 111. Alternatively, at least one of metal materials such as silver (Ag), aluminium (Al), and platinum (Pt) may be coated or plated on a surface of the light guide plate 110 to form the reflection layer 111. Alternatively, a thin silver foil may be attached to form the reflection layer 110. However, the reflection layer 111 is not limited to the material and manufacturing method thereof.

The reflection sheet 130 may be disposed below the light guide plate 110.

The reflection sheet 130 may reflect the light emitted through the under surface of the light guide plate 110 toward an emission surface of the light guide plate 110.

The reflection sheet 130 may be formed of a resin material having high reflectivity such as PET, PC, and PVC resins, but is not limited thereto.

FIG. 4 is a perspective view illustrating a light guide plate of a backlight unit according to a second embodiment.

Referring to FIG. 4, a frame 112 having a ‘U’ shape and serving as a reflection layer may be disposed on at least one side surface of a light guide plate 110.

The U-shaped frame 112 may be formed with metal material or a resin material. For example, the metal material may include at least one of Ag, Al, and Pt, and the resin material may include one of PET, PC, and PVC resins, but are not limited thereto.

For example, the U-shaped frame 112 may manufactured using a press forming process or an extrusion molding process.

The U-shaped frame 112 may reflect light incident to at least one side surface of the light guide plate 110 to minimize a light loss of a BLU.

FIG. 5 is a side view illustrating a light guide plate of a backlight unit according to a third embodiment.

Referring to FIG. 5, a reflection layer 113 may be disposed on a portion of a side surface on which a light emitting module 120 is disposed along with side surfaces of a light guide plate 110.

Specifically, a plurality of holes 114 may be defined in the reflection layer 113 disposed on the side surface on which the light emitting module 120 is disposed. The plurality of holes 114 may have configurations and arrangements corresponding to a light emitting device 122 of the light emitting module 120. Thus, light emitted from the light emitting device 122 may be incident to the light guide plate 110, but is not interrupted by the reflection layer 113.

That is, the configurations of the plurality of holes 114 may be determined in consideration of an incident angle of light emitted from the light emitting device 122 and a distance between the light emitting device 122 and the light guide plate 110.

Since the reflection layer 113 is disposed between the light emitting module 120 and the light guide plate 110, light loss through a gap between the light emitting module 120 and the light guide plate 110 may be minimized.

A display device including an optical sheet and a liquid crystal panel on a BLU according to the embodiments and including a panel support and a top cover receiving and supporting the optical sheet and the liquid crystal panel may be manufactured. Their detailed descriptions will be omitted as they are well understood by those skilled in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
a bottom cover;
a light guide plate on which a reflection layer is disposed on at least one side surface thereof, the light guide plate being disposed on an inside of the bottom cover; and
a light emitting module disposed on at least one side surface of the light guide plate.

2. The backlight unit according to claim 1, wherein the reflection layer is disposed on at least one side surface of the light guide plate other than a side surface on which the light emitting module is disposed.

3. The backlight unit according to claim 1, wherein the reflection layer is disposed on a portion of a side surface of the light guide plate on which the light emitting module is disposed.

4. The backlight unit according to claim 1, wherein a plurality of holes is defined at the reflection layer disposed on a side surface of the light guide plate on which the light emitting module is disposed.

5. The backlight unit according to claim 4, wherein configurations and arrangements of the plurality of holes are determined based on an incident angle of light emitted from a light emitting device mounted on the light emitting module and a distance between the light emitting device and the light guide plate.

6. The backlight unit according to claim 1, wherein the reflection layer is formed with a white photo solder resist (PSR) ink or oxide titanium (TiO₂).

7. The backlight unit according to claim 1, wherein the reflection layer is formed with at least one of silver (Ag), aluminium (Al), and platinum (Pt).

8. The backlight unit according to claim 1, wherein the reflection layer is formed with a silver foil is attached on at least one side surface of the light guide plate.

9. The backlight unit according to claim 1, wherein the reflection layer comprises a U-shaped frame disposed on at least one side surface of the light guide plate.

10. The backlight unit according to claim 1, wherein the light emitting module comprises a plurality of light emitting diodes.

11. The backlight unit according to claim 1, wherein the light guide plate has a thickness of 1 mm to 2 mm.

12. The backlight unit according to claim 1, wherein a scattering pattern is disposed on an under surface of the light guide plate.

13. A backlight unit comprising:
a bottom cover;
a light guide plate on which a reflection layer is disposed on at least one side surface thereof, the light guide plate being disposed on an inside of the bottom cover; and
a light emitting module disposed on an under surface of the light guide plate.

14. The backlight unit according to claim 13, wherein the reflection layer is disposed on all of side surfaces of the light guide plate.

15. The backlight unit according to claim 13, wherein the reflection layer is formed with a white photo solder resist (PSR) ink or oxide titanium (TiO₂).

16. The backlight unit according to claim 13, wherein the reflection layer is formed with at least one of silver (Ag), aluminium (Al), and platinum (Pt).

17. The backlight unit according to claim 13, wherein the reflection layer is formed with a silver foil attached on at least one side surface of the light guide plate.

18. The backlight unit according to claim 13, wherein the reflection layer comprises a U-shaped frame disposed on at least one side surface of the light guide plate.

19. A display device comprising:
a backlight unit comprising a bottom cover, a light guide plate on which a reflection layer is disposed on at least one side surface thereof, the light guide plate being disposed on an inside of the bottom cover, and a light emitting module disposed on at least one side surface of the light guide plate; and
a liquid crystal panel on the backlight unit.

20. The display device according to claim 19, wherein the reflection layer is formed with a white photo solder resist (PSR) ink or oxide titanium (TiO₂).

21. The backlight unit according to claim 1, wherein the reflection layer is disposed on at least three side surfaces of the light guide plate.
